(19) United States
(12) Patent Application Publication
(10) Pub. No.: US 2026/0296120 A1
(43) Pub. Date: Oct. 1, 2026

(54) Non-pneumatic Spring Wheel for Active Road Adaptation and Traction Conversion based on Elastic Deformation and Tilt-In-Out Mechanisms of Leaf type Spiral Springs

(71) Applicant: Sun T. Hong, san jose, CA (US)

(72) Inventor: Sun T. Hong, san jose, CA (US)

(21) Appl. No.: 19/665,899

(22) Filed: May 1, 2026

Related U.S. Application Data
(63) Continuation-in-part of application No. 16/928,209, filed on Jul. 14, 2020, now Pat. No. 11,351,818.

(51) Int. Cl. B60G 11/14

(52) U.S. Cl. CPC B60G 11/14; B60G 2202/11; B60G 2202/12

(57) ABSTRACT

A non-pneumatic spring wheel for active road adaptation is disclosed. The wheel features a tilt-in-out mechanism where spiral springs undergo elastic deformation to induce self-optimizing tilt and ‘in-out’ phenomena. This process converts the mechanical load of the vehicle into vertical downward pressure toward the ground, maximizing contact pressure to actively suppress oversteer and understeer. A dual-axis interlocking system (601, 402) ensures structural integrity during dynamic adaptation, making it suitable for high-performance vehicles, aircraft landing gears, and various multi-purpose mobility systems.

### CROSS-REFERENCE TO RELATED APPLICATIONS

This application is a Continuation-in-Part of U.S. patent application Ser. No. 16/928,209, filed on Jul. 14, 2020, now U.S. Pat. No. 11,351,818, the entire disclosure of which is incorporated herein by reference.

### TECHNICAL FIELD

The present invention relates to a non-pneumatic spring wheel using leaf-type spiral springs for active road adaptation. By converting the mechanical load of the vehicle into vertical downward pressure through a double cylindrical flange and leaf-type spiral springs, the system actively suppresses oversteer and understeer during maneuvers.

### DETAILED DESCRIPTION

### 1. Main Components and Dynamic Integration

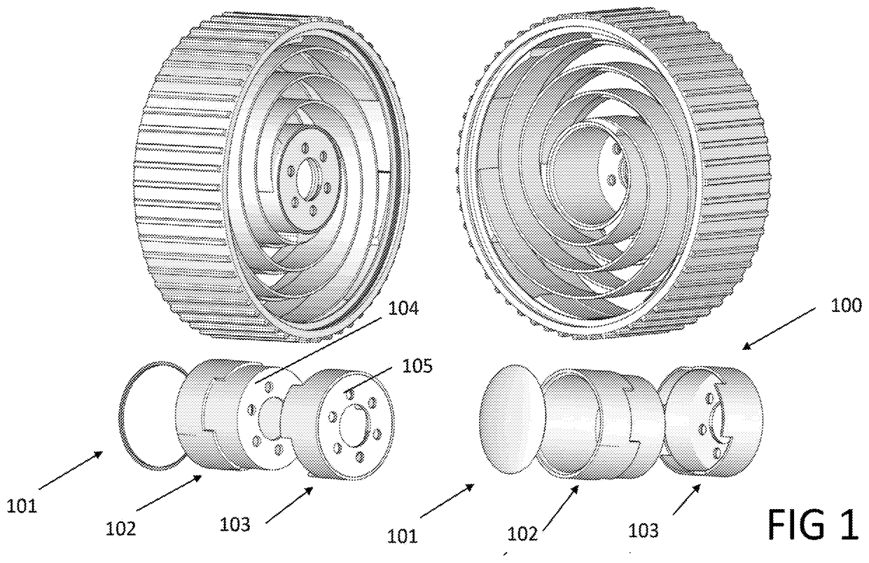

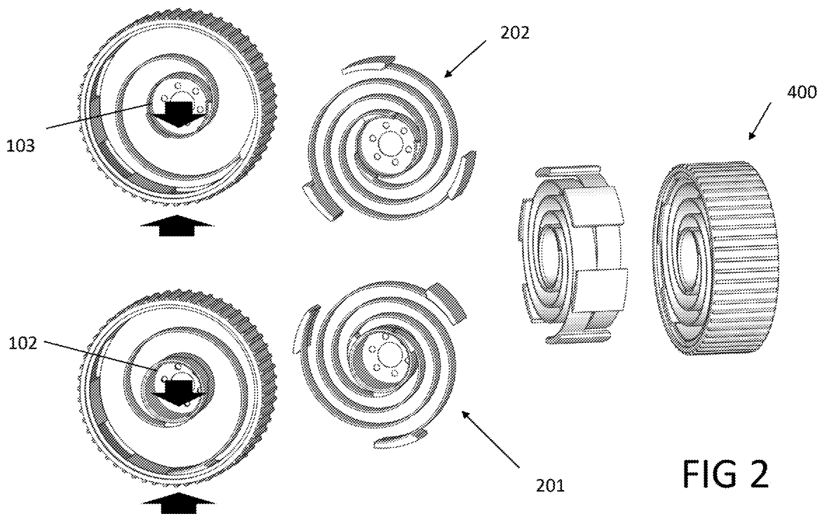

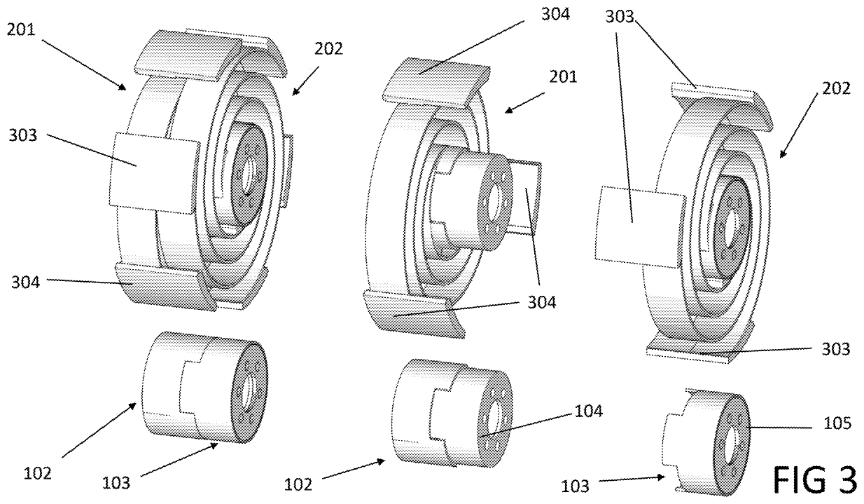

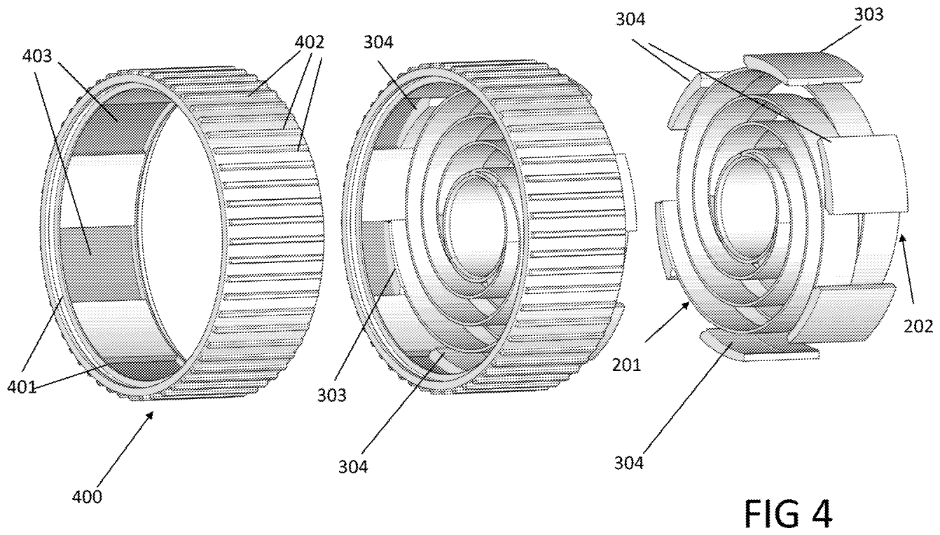

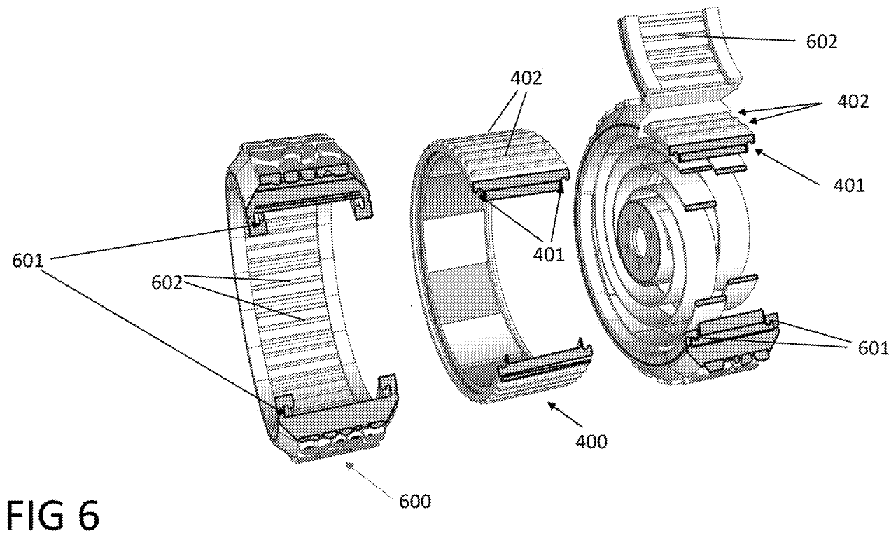

Double Cylindrical Flange (FIGS. 1, 3): The wheel hub features a double cylindrical flange structure (100) comprising an inner flange (102) and an outer flange (103), which are separated to enhance manufacturing and assembly efficiency. Reference numeral 101 denotes a hub cap. To suppress the sudden release of energy (catharsis), spiral spring groups (201, 202) are attached in different directions to each flange. Elements 104 and 105 represent perforated flanges on the inner and outer sides.
Cushioning and Mechanical Coupling (FIGS. 2, 3, 4): Multiple leaf-type spiral springs (201, 202) are arranged between the flanges and the ground. The square structures (303, 304) at the spring ends are seated in rectangular recesses (403) of the ring spring (400) for secure mechanical locking, simulating air cushion performance.
Double Interlock System for Stability (FIG. 6): To support the dynamic traction conversion, a dual-axis interlocking system is employed. The link (601) hooks into the groove (401) of the ring spring to provide lateral restraint, while the hump (402) inserts into the inner groove (602) of the rubber shoe (600) to ensure rotational stability. This prevents detachment or slipping during high-speed shifts.

### 2. Traction Conversion Mechanism and Road Adaptation

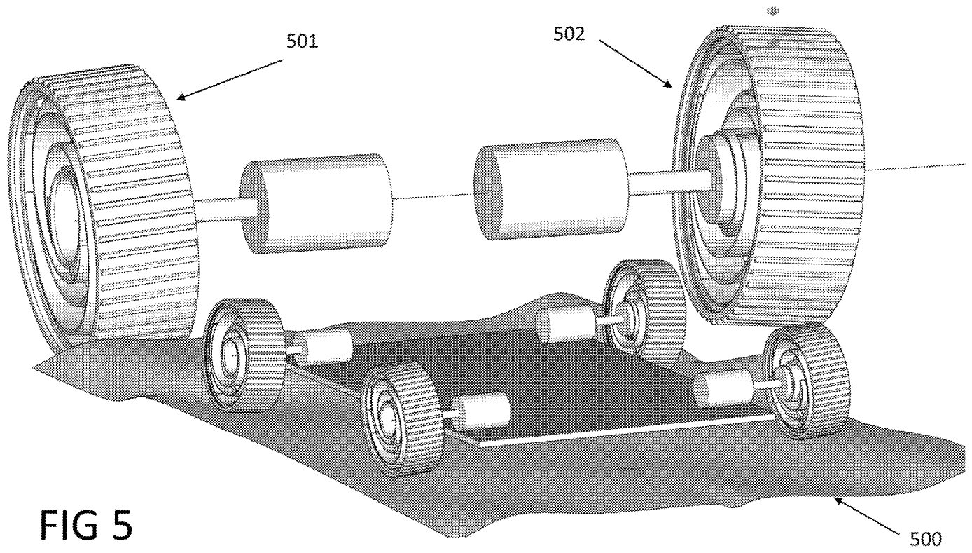

Road-Adaptive Tilt (FIG. 5): The flexible leaf spring structure allows the wheel to tilt (501, 502) relative to the axle, ensuring the contact patch adheres closely to rough terrains (500).

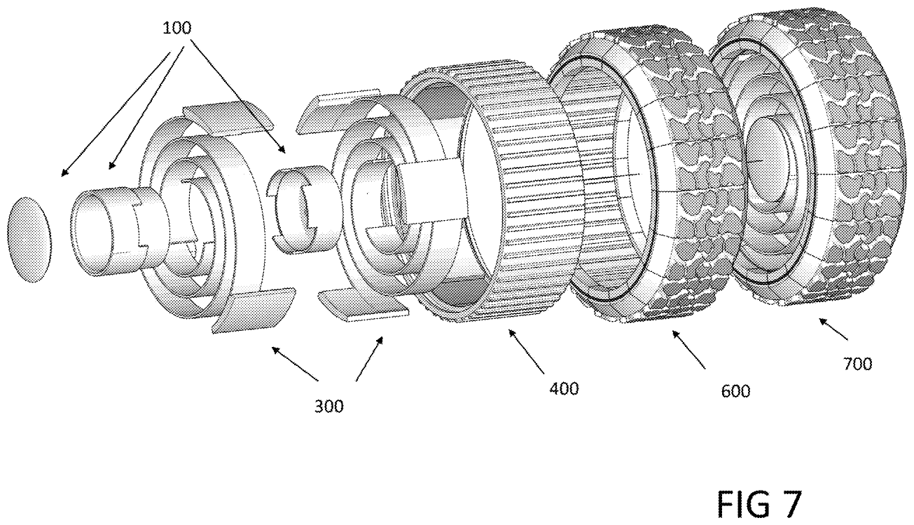

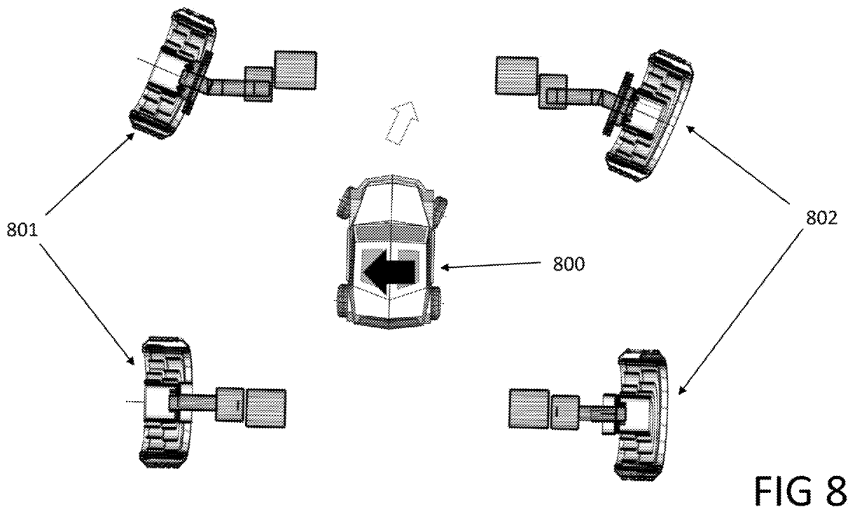

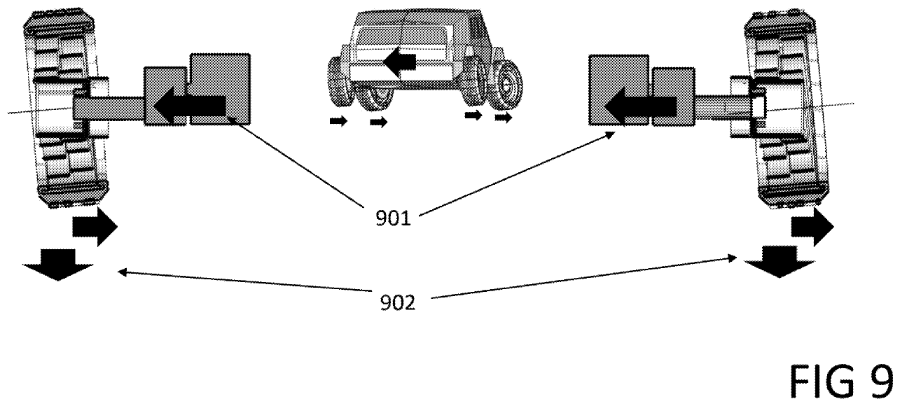

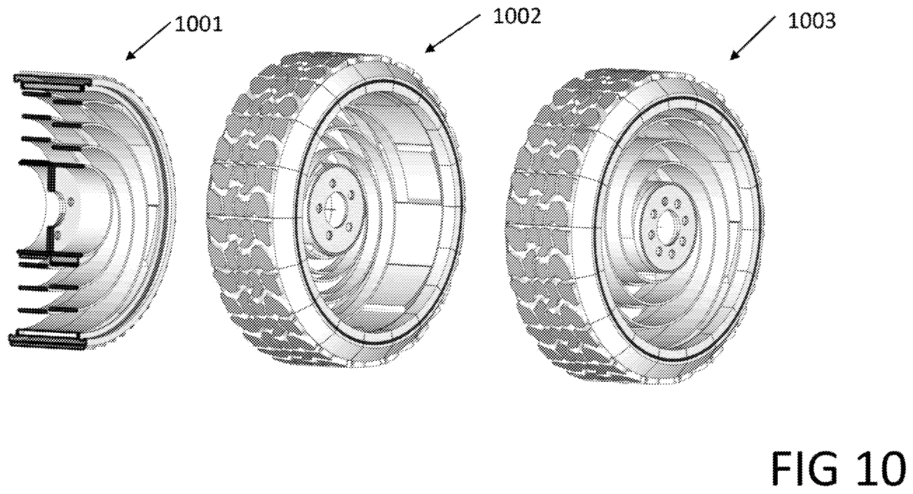

Load Conversion Mechanism (FIGS. 8, 9): Under dynamic driving loads, the spiral springs undergo elastic deformation to trigger the ‘in-out’ and tilt phenomena. Crucially, this mechanism converts the dynamic driving load into vertical downward pressure (902) toward the ground. This “dig-in” effect maximizes unit contact pressure and physically suppresses oversteer and understeer.
Final Assembly and Embodiments (FIGS. 7, 10): The final assembly (700) integrates the flange (100), springs (300), ring spring (400), and shoe (600) into a single system. The wheel is applicable to moon rovers (1002) and standard vehicles (1003) via offset adjustment and varied flange hole (1004 ) configurations.

1. A non-pneumatic spring wheel for active road adaptation, comprising: a double structure hub (100) having inner (102) and outer (103) cylindrical flanges; a plurality of leaf-type spiral springs (201, 202) attached to each of the flanges; a ring spring (400) having rectangular recesses (403); and a rubber shoe (600) wherein the flanges are configured to laterally shift in response to centrifugal force to induce tilt and in-out phenomena, thereby actively converting centrifugal force into vertical ground pressure to control friction.

2. The spring wheel of claim 1, wherein the square structures at the ends of the springs are mechanically locked into the rectangular recesses (403) of the ring spring (400).

3. The spring wheel of claim 1, further comprising a dual-axis interlocking structure where a link (601) prevents lateral detachment of the shoe and a hump (402) prevents rotational slipping to ensure system integrity during traction conversion.

4. The spring wheel of claim 1, featuring a function to suppress understeer and oversteer by self-optimizing camber and toe angles through the conversion of lateral centrifugal force into vertical traction pressure.
